(19) United States
(12) Patent Application Publication
(10) Pub. No.: US 2021/0295330 A1
(43) Pub. Date: Sep. 23, 2021

(54) METHOD AND SYSTEM TO REPRESENT SCALAR DIGITAL ASSETS USING HASH CHAINS

(71) Applicant: MASTERCARD INTERNATIONAL INCORPORATED, Purchase, NY (US)

(72) Inventor: Steven C. DAVIS, Saint Peters, MO (US)

(73) Assignee: MASTERCARD INTERNATIONAL INCORPORATED, Purchase, NY (US)

(21) Appl. No.: 17/204,316

(22) Filed: Mar. 17, 2021

Related U.S. Application Data
(60) Provisional application No. 62/992,219, filed on Mar. 20, 2020.

(51) Int. Cl. G06Q 20/40; G06Q 20/38

(52) U.S. Cl. CPC G06Q 20/401; G06Q 2220/00; G06Q 20/3827

(57) ABSTRACT

A method and system for representing scalar digital assets using hash chains may include a processor which may receive a data request for one or more units of a scalar digital asset from a computing device. The processor may identify the scalar digital asset requested by the computing device and the one or more units of the scalar digital asset. The processor may verify the computing device has access to the scalar digital asset. The processor may generate a hash chain of the one or more units of the scalar digital asset and transmit a data response message containing the hash chain of the one or more units of the scalar digital asset to the computing device.

### FIELD

The present disclosure generally relates to representing scalar digital assets using hash chains, specifically the use of hash chains to enable auditable traceability of scalar digital assets in an offline environment.

### BACKGROUND

In recent times, digital currencies have seen increased usage over traditional fiat currencies. Many digital currencies utilize blockchain technology to reduce the chances of the so-called “double-spend” problem. Double-spending is the risk that a digital currency can be spent twice by a digital currency holder who can manipulate the network to his/her advantage. Blockchain technology prevents this “double-send” problem using an immutable shared ledger where each transaction is confirmed and verified by the blockchain network in the order the transactions occur. Thus, the first spend of a digital currency would be confirmed and verified before the second “double” spend, which would be identified as invalid by the blockchain network. However, current technologies require the digital currency to be connected to the blockchain network in order for such double-spend security mechanism to work.

A technical problem inherent to most asset-based systems is how one can uniquely identify individual assets efficiently. While unique identifiers can be randomly chosen, there has to be a way to check for and avoid conflicts, and if large numbers of assets are being conveyed, the data stream can become prohibitively large. Hence, there is a need for a way to uniquely identify individual assets without fear of conflicts while providing the ability to identify potentially large numbers of assets by range or groups, etc.

### SUMMARY

The present disclosure provides a description of exemplary systems and methods for representing scalar digital assets using hash chains. The methods and systems may include a processor which may receive a data request for one or more units of a scalar digital asset from a computing device. The processor may identify the scalar digital asset requested by the computing device and the one or more units of the scalar digital asset. The processor may verify the computing device has access to the scalar digital asset. The processor may generate a hash chain of the one or more units of the scalar digital asset and transmit a data response message containing the hash chain of the one or more units of the scalar digital asset to the computing device.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for performing representation of scalar digital assets using hash chains.

FIG. 2 is a block diagram illustrating a computing system of the system of FIG. 1 for performing representation of scalar digital assets using hash chains in accordance with exemplary embodiments.

FIG. 3 is a flow diagram illustrating a process for representing scalar digital assets using hash chains in the system of FIG. 1 in accordance with exemplary embodiments.

FIG. 4 is a flow chart illustrating exemplary methods for representing scalar digital assets using hash chains in accordance with exemplary embodiments.

FIG. 5 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order, or may be presented in any other order that may be suitable for use by the blockchain network. In some configurations, transactions recorded in the blockchain may include a destination address and a currency amount, such that the blockchain records how much currency is attributable to a specific address. In some instances, additional information may be captured, such as a source address, timestamp, etc. In some embodiments, a blockchain may also consist of additional, and in some instances arbitrary, data that is confirmed and validated by the blockchain network through proof of work and/or any other suitable verification techniques associated therewith. In some cases, such data may be included in the blockchain as part of transactions, such as included in additional data appended to transaction data. In some instances, the inclusion of such data in a blockchain may constitute a transaction. In such instances, a blockchain may not be directly associated with a specific digital, virtual, fiat, or other type of currency.

System for Representation of Scalar Digital Assets Using Hash Chains

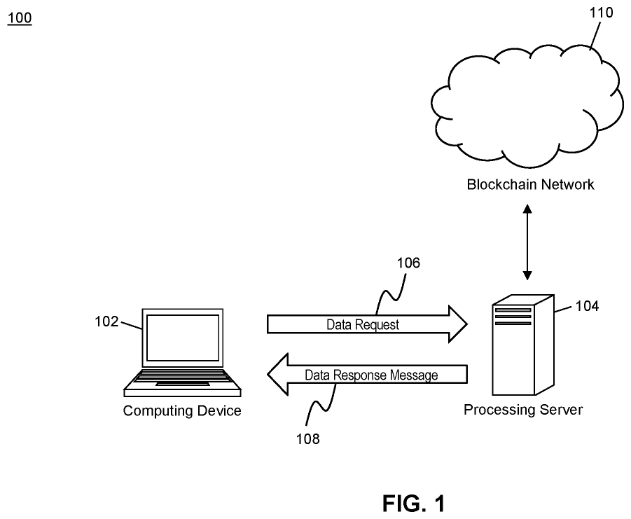

FIG. 1 illustrates a system 100 for the representation of scalar digital assets using hash chains.

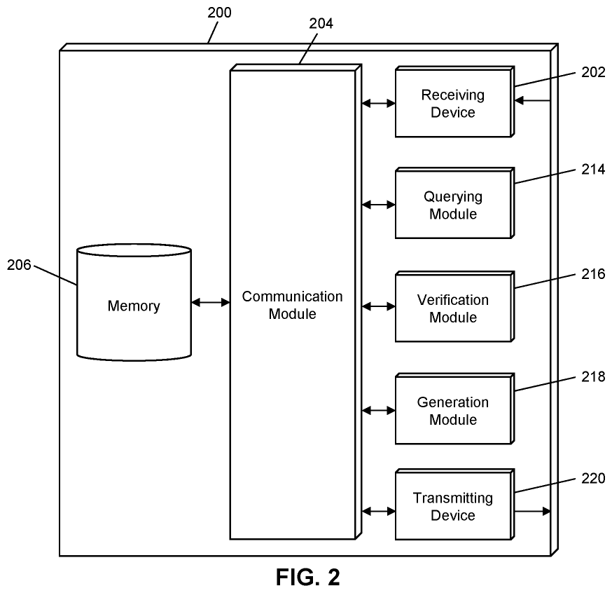

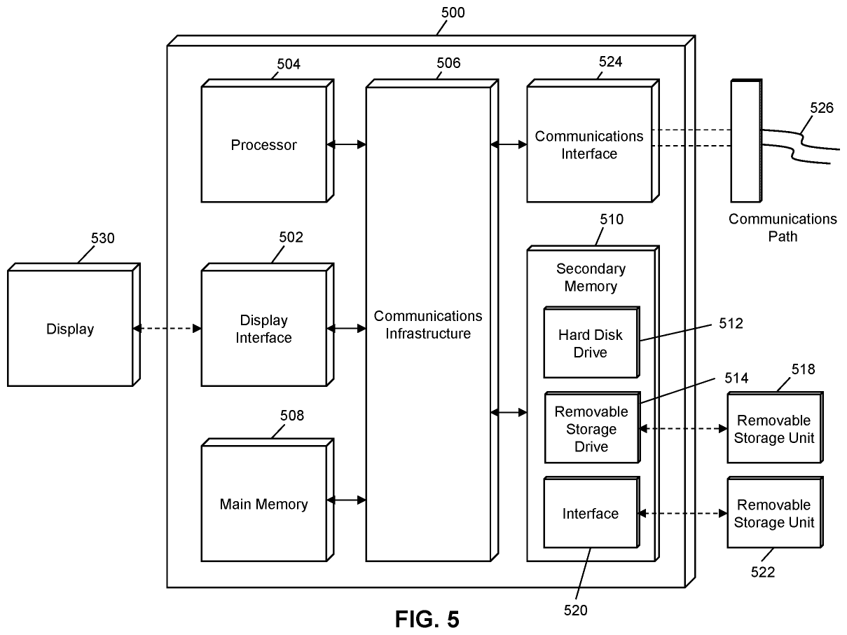

In the system 100, a computing device 102 may operate as a client device and communicate with a processing server 104. In an exemplary embodiment, the processing server 104 may operate as, but is not limited to, a scalar digital asset moderator and/or regulator. For example, the processing server 104 may operate as a currency moderator, such as, but not limited to, a bank or other financial institution. Other types of assets would have other moderators, e.g., content providers or licensing authorities for instance. The computing device 102 and processing server 104 may be any type of computing system that is specially configured to perform the functions discussed herein, such as the computing system 200 illustrated in FIG. 2 or the computing system 500 illustrated in FIG. 5, as discussed in more detail below.

In the system 100, the computing device 102 may electronically transmit a data request 106 to the processing server 104. In an exemplary embodiment, the data request 106 may be for a scalar digital asset stored on the blockchain network 110. A scalar asset may be any asset such as, but not limited to, a digital, virtual, fiat, or other type of currency, a data file, or any other type of digital asset that may be quantified using a real number. A scalar digital asset may be capable of being broken down into one or more units that make up the whole scalar digital asset. For example, the computing device may electronically transmit a data request 106 to the processing server 104 for twenty U.S. Dollars, i.e., the scalar digital asset, which may be broken down into units of dollar and cents, e.g., two ten dollar bills, four five dollar bills, twenty one dollar bills, or two thousand cents, mixtures thereof, etc. Because the hash chain can be of virtually any length, the units would likely be the smallest denomination. Further, the data request 106 may include credentials associated with the computing device 102 such as, but not limited to, a username, a password, an account number, or any other identifying information, etc. The computing device 102 may electronically transmit the data request 106 to the processing server 104 using any suitable communication network such as, but not limited to, the communications infrastructure 506 illustrated in FIG. 5

In the system 100, the processing server 104 may receive the data request 106 for the scalar digital asset stored on the blockchain network 110. In an exemplary embodiment, the processing server 104 may be a node associated with the blockchain network 110 and configured to post blockchain transactions and/or blocks of blockchain transactions to a blockchain associated therewith. In other embodiments, the processing server 104 may be configured to electronically communicate with an intermediate computing device, which may be a node of the blockchain network 110. Communications between the processing server 104 and the blockchain network 110 and/or intermediate computing device may be performed using any suitable communication network, such as, but not limited to, the Internet.

The processing server 104 may verify the computing device 102 has access to the requested scalar digital asset stored on the blockchain network 110. In an embodiment, the processing server 104 may query a memory associated with the processing server 104 that stores a record of all assets associated with the computing device 102. In another embodiment, the processing server may store credentials such as but not limited to, a user name, account numbers, a private key an/or a public key associated with the computing device 102 and the blockchain network 110 allowing the processing server 104 to access assets associated with the computing device 102 stored on the blockchain network 110. For example, the processing server 104 may operate as a scalar digital asset moderator and/or regulator and thus control access to the blockchain network 110 by the computing device 102.

The processing server 104 may identify one or more units of the scalar digital asset requested in the data request 106. In exemplary embodiment, the processing server 104 may identify the smallest units of the requested digital scalar asset. Continuing with the example above, if the data request 106 is for twenty U.S. Dollars, the processing server 104 may identify two thousand units, representing the two thousand cents, i.e., the smallest denomination of the U.S. Dollar, as the one or more units of the requested scalar digital asset. In another embodiment, the processing server 104 may identify a defined unit of the requested scalable asset where the defined unit is a unit larger than the smallest unit of the requested scalable asset. Continuing with the example above, if the data request 106 is for twenty U.S. Dollars, the processing server 104 may identify two units representing two ten dollar bills, four units representing four five dollar bills, or twenty units representing twenty one dollar bills, etc.

The processing server 104 generates a hash chain to represent the scalar digital asset requested by the computing device 102 in the data request 106. A hash chain is created by taking an initial value and applying a hashing algorithm to generate a subsequent value, where the hash is a one-way hash, preventing any entity from identifying the initial value from the subsequent value. This process is repeated a large number of times, where the hash value that is created is subsequently hashed over and over, creating a chain starting with the initial value that has thus been hashed potentially thousands of times. For instance, the processing server 104 may generate an initial secret value X. Once the initial secret value X is identified, the processing server 104 may hash the initial value by applying a hashing algorithm thereto to obtain a new hash value, referred to herein as H(X0). The hashing algorithm may be a one-way cryptographic hash function such that there is no way to identify X from H(X0). Once the hash value H(X0) has been obtained, the processing server 104 may repeat the process by hashing the value again to obtain the hash value H(H(X0)), also referred to herein as H(X1). The computing device 102 may continue to repeat the process a large number, N, of times to arrive at a final value H(XN) in the hash chain that would look something like this:

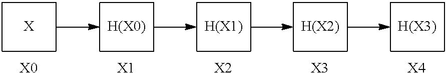

In an exemplary embodiment, the processing server 104 generates a hash chain of the scalar digital asset requested by the computing device 102 by taking a random secret value (X) and then applying an agreed hash digest function (H) for each unit of the scalar digital asset. The random secret value (X) may be an initial value that is randomly or pseudo-randomly generated, selected by the user of the computing device 102, or otherwise identified using any suitable method. The hash digest function may be any cryptographic hash function, such as but not limited to, SHA-256. This process results in a deterministic and unique chain of connected hashes. Continuing with the example above where the requested scalar digital asset is twenty U.S. Dollars, the processing server 104 would apply the hash digest function (H) two thousand times resulting in a hash chain that is two-thousand hashes long, with each hash representing one cent. Therefore, each unit, e.g., cent, of the scalar digital asset, e.g., twenty U.S. Dollars, would have a unique, immutable identifier in the two-thousand hash chain.

The processing server 104 may electronically transmit a data response message 108 to the computing device 102 with the requested data. In an exemplary embodiment, the data response message 108 includes the hash chain of the requested scalar digital asset. For instance, in the above example, the data response message would include the two-thousand chain hash chain, which represents each cent of the twenty U.S. Dollars requested by the computing device 102. In an exemplary environment, the processing sever 104 transmits the hash chain of the requested scalar digital asset to the computing device 102 for use in an offline environment. For example, the computing device 102 may transmit all or part of the scalar digital asset to another computing device. Continuing with the above example, the computing device may transmit all two-thousand units of the twenty U.S. Dollars, or a designated portion of the two-thousand units representing the twenty U.S. Dollars, e.g., one-thousand units representing ten U.S. Dollars, or one-hundred units representing one U.S. Dollar.

Currently, there is a need to support offline use cases where a shared digital ledger, or blockchain, is not available to provide double spending protection. The methods and system discussed herein allow the computing device 102 to transmit the scalar digital asset represented by a hash chain to other computing devices in an offline environment in a traceable and auditable way. Since each hash in the hash chain represents a single unit of the scalar digital asset, each unit of the scalar digital asset will retain its identity and will have a unique and immutable origin, the original secret value X, no matter how many times each unit is transferred offline by the computing device 102. Thus, the methods and systems discussed herein provide a novel solution, not addressed by current technology, for an auditable and traceable way to transfer scalar digital assets in an offline environment using hash chains. Further, the methods and systems discussed herein provide for the unit-level tracing of values via hash chains of scalar digital assets exchanged directly between users in an offline environment.

Computing System

FIG. 2 illustrates an embodiment of a computing system 200, such as may serve as the computing device 102 and/or processing server 104 in the system 100. It will be apparent to persons having skill in the relevant art that the embodiment of the computing system 200 illustrated in FIG. 2 is provided as illustration only and may not be exhaustive to all possible configurations of the computing system 200 suitable for performing the functions as discussed herein. For example, the computer system 500 illustrated in FIG. 5 and discussed in more detail below may be a suitable configuration of the computing system 200.

The computing system 200 may include a receiving device 202. The receiving device 202 may be configured to receive data over one or more networks via one or more network protocols. In some instances, the receiving device 202 may be configured to receive data from computing devices 102, processing server 104, and other systems and entities via one or more communication methods, such as radio frequency, local area networks, wireless area networks, personal area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by computing device 102 that may be superimposed or otherwise encoded with data request 106. The receiving device 202 may also be configured to receive data signals electronically transmitted by processing servers 104, which may be superimposed or otherwise encoded with data response messages 108, which may include a hash value.

The computing system 200 may also include a communication module 204. The communication module 204 may be configured to transmit data between modules, engines, databases, memories, and other components of the computing system 200 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the computing system 200 and external components of the computing system 200, such as externally connected databases, display devices, input devices, etc. The computing system 200 may also include a processing device. The processing device may be configured to perform the functions of the computing system 200 discussed herein as will be apparent to persons having skill in the relevant art. In some embodiments, the processing device may include and/or be comprised of a plurality of engines and/or modules specially configured to perform one or more functions of the processing device, such as a querying module 214, verification module 216, generation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The computing system 200 may also include a memory 206. The memory 206 may be configured to store data for use by the computing system 200 in performing the functions discussed herein, such as public and private keys, symmetric keys, etc. The memory 206 may be configured to store data using suitable data formatting methods and schema and may be any suitable type of memory, such as read-only memory, random access memory, etc. The memory 206 may include, for example, encryption keys and algorithms, communication protocols and standards, data formatting standards and protocols, program code for modules and application programs of the processing device, and other data that may be suitable for use by the computing system 200 in the performance of the functions disclosed herein as will be apparent to persons having skill in the relevant art. In some embodiments, the memory 206 may be comprised of or may otherwise include a relational database that utilizes structured query language for the storage, identification, modifying, updating, accessing, etc. of structured data sets stored therein. The memory 206 may be configured to store, for example, cryptographic keys, salts, nonces, communication information for the back-end system, etc.

The memory 206 may be configured to store a hash chain and data associated therewith. In computing device 102, the memory 206 may store one or more initial values and any hash chain values associated therewith. In the computing device 102, the memory 206 may store a received hash chain as part of a transmitted data response message 108 for use in an offline transfer of a scalar digital asset. Further, in the computing device 102, the memory 206 may store any subsequent transfers of one or more units of the scalar digital asset represented by the hash chain. In the processing server 104, the memory 206 may store the random secret value X, i.e., the initial value used to start the hash chain. The memory 206 of the processing server 104 may store the public and private keys associated with the computing device 102 for querying the blockchain network 110 for access to a scalar digital asset requested by the computing device 102. Further, the memory 206 of the processing server 104 may store the hash chain created as part of a transmitted data response message 108 for use in an offline transfer of a scalar digital asset by the computing device 102.

The computing system 200 may include a querying module 214. The querying module 214 may be configured to execute queries on databases to identify information. The querying module 214 may receive one or more data values or query strings, and may execute a query string based thereon on an indicated database, such as the memory 206 of the computing system 200 to identify information stored therein. The querying module 214 may then output the identified information to an appropriate engine or module of the computing system 200 as necessary. The querying module 214 may, for example, execute a query on the memory 206 of the computing system 200 to identify the requested scalar digital asset to be hashed into a hash chain for inclusion in a data response message 108 to be transmitted to the computing device 102. The querying module 214 may also, for example, execute a query on the memory 206 of the computing system 200 to identify one or more units that make up a scalar digital asset associated with the computing device 102.

The computing system 200 may also include a verification module 216. The verification module 216 may be configured to perform verifications for the computing system 200 as part of the functions discussed herein. The verification module 216 may receive instructions as input, which may include data to be verified and/or data to be used in the verification. The verification module 216 may perform a verification as requested and may output a result of the verification to another module or engine of the computing system 200. The verification module 216 may, for example, be configured to verify that the computing device 102 has access to a requested scalar digital asset stored on the blockchain network 110.

The computing system 200 may also include a generation module 218. The generation module 218 may be configured to generate data for use by the computing system 200 in performing the functions discussed herein. The generation module 218 may receive instructions as input, may generate data based on the instructions, and may output the generated data to one or more modules of the computing system 200. For example, the generation module 218 may be configured to generate a hash chain via the application of hash digest functions to initial values, such as for use in representing a scalar digital asset, for transmission to a computing device 102.

The computing system 200 may also include a transmitting device 220. The transmitting device 220 may be configured to transmit data over one or more networks via one or more network protocols. In some instances, the transmitting device 220 may be configured to transmit data to computing devices 102, processing servers 104, blockchain networks 110 and other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 220 may electronically transmit data signals that have data superimposed that may be parsed by a receiving computing device. In some instances, the transmitting device 220 may include one or more modules for superimposing, encoding, or otherwise formatting data into data signals suitable for transmission.

The transmitting device 220 may be configured to electronically transmit data signals to processing servers 104 that are superimposed or otherwise encoded with data request 106, which may include data used in the functions as discussed herein. The transmitting device 220 may also be configured to electronically transmit data signals to computing device 102 that may be superimposed or otherwise encoded with a data response message 108, such as may include a hash chain representing a one or more units of a scalar digital asset or any other information transmitted to the computing device 102 in response to a data request 106.

Process for Representation of a Scalar Digital Asset Using Hash Chains

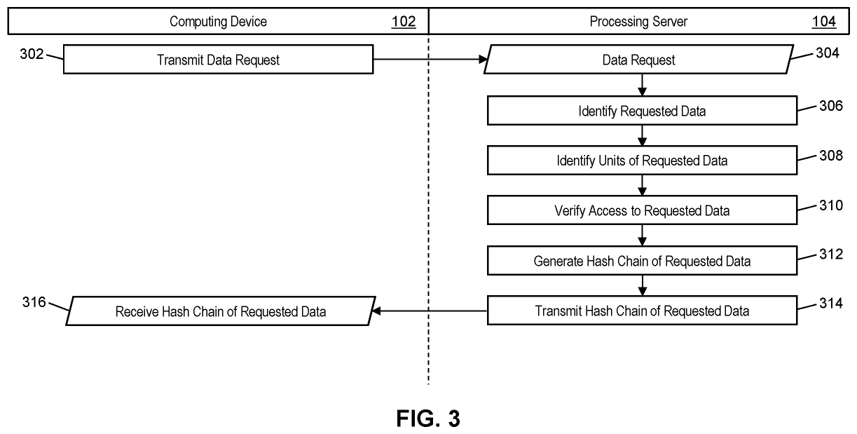

FIG. 3 illustrates an example process executed in the system 100 of FIG. 1 for the representation of a scalar digital asset using a hash chain.

In step 302, the computing device 102 may electronically transmit (e.g., via a transmitting device 220) a data request 106 to the processing server 104 to start a communication session therewith using any suitable communication method. In step 304, the processing server 104 may receive (e.g., via a receiving device 202) the data request 106, where the data request may include a request for one or more units of a scalar digital asset stored on the blockchain network 110.

In step 306, the processing server 104 may identify (e.g., via a query executed by a querying module 214) the scalar digital asset requested by the computing device 102 on the blockchain network 110 via the data request 106. Further, at step 308, the processing server may identify (e.g., via a query executed by a querying module 214) the one or more units of the requested scalar digital asset. It should be noted that a total of hash values can be identified by a range, e.g., “X1-X4” would identify four cents in one example, thus avoiding the need to identify X1, X2, X3, X4. This greatly reduces the need to convey large numbers of assets using a relatively small set of data values.

In step 310, the processing may verify (e.g., via a query executed by a querying module 214) that the computing device 102 has access to the requested scalar digital asset stored on the blockchain network 110.

In step 312, the processing server may generate may (e.g., via a generation module 218 thereof) a hash chain of the one or more identified units of the requested scalar digital asset by applying a hash digest function using a random initial value to each unit of the requested scalar digital asset.

In step 314, the processing server may transmit (e.g., via a transmitting device 220) a data response message 108 to the computing device 102. At step 316, the computing device 102 may receive (e.g., via a receiving device 202 thereof) the data response message 108 containing the hash chain representing the scalar digital asset requested in the data request 106.

Exemplary Method for Representing Scalar Digital Assets Using Hash Chains

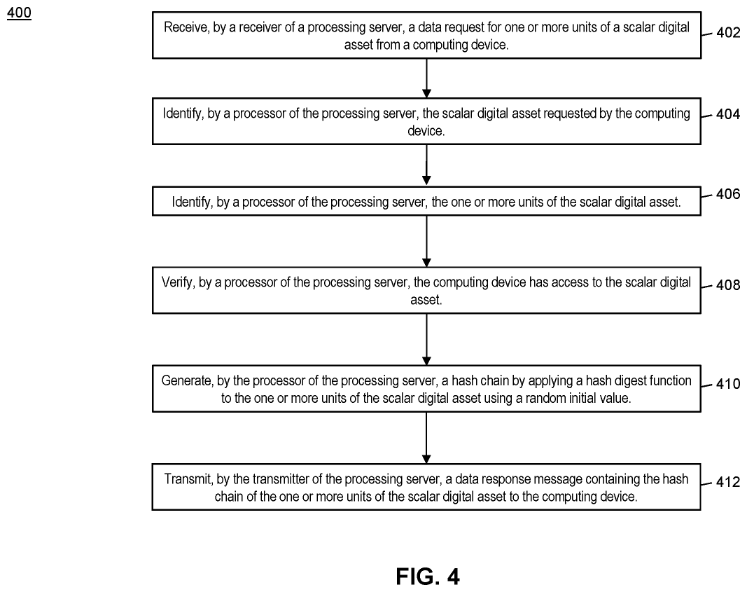

FIG. 4 illustrates a method 400 for the representation of a scalar digital asset using a hash chain in the perspective of the processing server 104 in the system 100 of FIG. 1.

In step 402, a data request (e.g., data request 106) may be received from a computing device (e.g., the computing device 102) by a receiver (e.g., the receiving device 202) of a processing server (e.g., the processing server 104). The data request may be for one or more units of a scalar digital asset stored on a distributed ledger (e.g., the blockchain network 110) moderated and/or regulated by the processing server 104.

In step 404, the scalar digital asset requested by the computing device (e.g., the computing device 102) may be identified by the processing server (e.g., via a query executed by a querying module 214) on the distributed ledger.

In step 406, the processing server may identify by a processor (e.g., via a query executed by a querying module 214) one or more units of the scalar digital asset requested by the client device. The processing server may identify a number of smallest units of the scalar digital asset or a designated unit size of the scalar digital asset.

In step 408, the processing server may verify by a processor (e.g., the verification module 216) that the computing device has access to the requested scalar digital asset stored on the distributed ledger.

In step 410, the processing server may generate by a processor (e.g., the generation module 218) of the processing server, a hash chain by applying a hash digest function to the one or more units of the scalar digital asset using a random initial value. This results in a hash chain representing the requested scalar digital asset by applying a hash digest function using a random initial value to each identified unit of the requested scalar digital asset.

In step 412, a data response message (e.g., data response message 108) containing the hash chain of the one or more units of the scalar digital asset may be transmitted by the transmitter (e.g., the transmitting device 220) of the processing server to the computing device.

Computer System Architecture

FIG. 5 illustrates a computer system 500 in which embodiments of the present disclosure, or portions thereof, may be implemented as computer-readable code. For example, the computing device 102 and processing server 104 of FIG. 1 and the computing system 200 of FIG. 2 may be implemented in the computer system 500 using hardware, software executed on hardware, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-4.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 518, a removable storage unit 522, and a hard disk installed in hard disk drive 512.

Various embodiments of the present disclosure are described in terms of this example computer system 500. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 504 may be a special purpose or a general purpose processor device specifically configured to perform the functions discussed herein. The processor device 504 may be connected to a communications infrastructure 506, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 500 may also include a main memory 508 (e.g., random access memory, read-only memory, etc.), and may also include a secondary memory 510. The secondary memory 510 may include the hard disk drive 512 and a removable storage drive 514, such as a floppy disk drive, a magnetic tape drive, an optical disk drive, a flash memory, etc.

The removable storage drive 514 may read from and/or write to the removable storage unit 518 in a well-known manner. The removable storage unit 518 may include a removable storage media that may be read by and written to by the removable storage drive 514. For example, if the removable storage drive 514 is a floppy disk drive or universal serial bus port, the removable storage unit 518 may be a floppy disk or portable flash drive, respectively. In one embodiment, the removable storage unit 518 may be non-transitory computer readable recording media.

In some embodiments, the secondary memory 510 may include alternative means for allowing computer programs or other instructions to be loaded into the computer system 500, for example, the removable storage unit 522 and an interface 520. Examples of such means may include a program cartridge and cartridge interface (e.g., as found in video game systems), a removable memory chip (e.g., EEPROM, PROM, etc.) and associated socket, and other removable storage units 522 and interfaces 520 as will be apparent to persons having skill in the relevant art.

Data stored in the computer system 500 (e.g., in the main memory 508 and/or the secondary memory 510) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 500 may also include a communications interface 524. The communications interface 524 may be configured to allow software and data to be transferred between the computer system 500 and external devices. Exemplary communications interfaces 524 may include a modem, a network interface (e.g., an Ethernet card), a communications port, a PCMCIA slot and card, etc. Software and data transferred via the communications interface 524 may be in the form of signals, which may be electronic, electromagnetic, optical, or other signals as will be apparent to persons having skill in the relevant art. The signals may travel via a communications path 526, which may be configured to carry the signals and may be implemented using wire, cable, fiber optics, a phone line, a cellular phone link, a radio frequency link, etc.

The computer system 500 may further include a display interface 502. The display interface 502 may be configured to allow data to be transferred between the computer system 500 and external display 530. Exemplary display interfaces 502 may include high-definition multimedia interface (HDMI), digital visual interface (DVI), video graphics array (VGA), etc. The display 530 may be any suitable type of display for displaying data transmitted via the display interface 502 of the computer system 500, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 508 and secondary memory 510, which may be memory semiconductors (e.g., DRAMs, etc.). These computer program products may be means for providing software to the computer system 500. Computer programs (e.g., computer control logic) may be stored in the main memory 508 and/or the secondary memory 510. Computer programs may also be received via the communications interface 524. Such computer programs, when executed, may enable computer system 500 to implement the present methods as discussed herein. In particular, the computer programs, when executed, may enable processor device 504 to implement the methods illustrated by FIGS. 3-4, as discussed herein. Accordingly, such computer programs may represent controllers of the computer system 500. Where the present disclosure is implemented using software, the software may be stored in a computer program product and loaded into the computer system 500 using the removable storage drive 514, interface 520, and hard disk drive 512, or communications interface 524.

The processor device 504 may comprise one or more modules or engines configured to perform the functions of the computer system 500. Each of the modules or engines may be implemented using hardware and, in some instances, may also utilize software, such as corresponding to program code and/or programs stored in the main memory 508 or secondary memory 510. In such instances, program code may be compiled by the processor device 504 (e.g., by a compiling module or engine) prior to execution by the hardware of the computer system 500. For example, the program code may be source code written in a programming language that is translated into a lower level language, such as assembly language or machine code, for execution by the processor device 504 and/or any additional hardware components of the computer system 500. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 500 to perform the functions disclosed herein. It will be apparent to persons having skill in the relevant art that such processes result in the computer system 500 being a specially configured computer system 500 uniquely programmed to perform the functions discussed above.

Techniques consistent with the present disclosure provide, among other features, systems and methods for authentication of a client device using a hash chain. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for representing scalar digital assets using hash chains, the method comprising:
receiving, by a receiver of a processing server, a data request for one or more units of a scalar digital asset from a computing device;
identifying, by a processor of the processing server, the scalar digital asset requested by the computing device;
identifying, by a processor of the processing server, the one or more units of the scalar digital asset;
verifying, by a processor of the processing server, the computing device has access to the scalar digital asset;
generating, by the processor of the processing server, a hash chain of the one or more units of the scalar digital asset; and
transmitting, by a transmitter of the processing server, a data response message containing the hash chain of the one or more units of the scalar digital asset to the computing device.

2. The method of claim 1, wherein generating, by the processor of the processing server, a hash chain of the one or more units of the scalar digital asset further comprises:
applying, by the processor of the processing server, a hash digest function to each of the one or more units of the scalar digital asset using a random initial value.

3. The method of claim 2, wherein each unit of the one or more units of the scalar digital asset is represented by a single hash in the hash chain.

4. The method of claim 2, wherein a range of the one or more units of the scalar digital asset is represented by a start hash and an end hash.

5. The method of claim 1, wherein the scalar digital asset is a digital currency.

6. The method of claim 1, wherein one unit of the one or more units of the scalar digital asset is the smallest unit of the scalar digital asset.

7. The method of claim 1, wherein one unit of the one or more units of the scalar digital asset is a designated unit size of the scalar digital asset.

8. The method of claim 1, wherein the scalar digital asset is stored on a blockchain network.

9. The method of claim 1, wherein the hash chain is transferrable in an offline environment by the first computing device to a secondary computing device.

10. The method of claim 1, wherein a designated range of the hash chain is transferrable in an offline environment by the first computing device to a secondary computing device.

11. A system for representing scalar digital assets using hash chains, the system comprising:
one or more processors, one or more computer-readable memories, one or more computer-readable tangible storage devices, and instructions stored on at least one of the one or more storage devices for execution by at least one of the one or more processors via at least one of the one or more memories, the instructions comprising:
instructions to receive, by a receiver of a processing server, a data request for one or more units of a scalar digital asset from a computing device;
instructions to identify, by a processor of the processing server, the scalar digital asset requested by the computing device;
instructions to identify, by a processor of the processing server, the one or more units of the scalar digital asset;
instructions to verify, by a processor of the processing server, the computing device has access to the scalar digital asset;
instructions to generate, by the processor of the processing server, a hash chain of the one or more units of the scalar digital asset; and
instructions to transmit, by a transmitter of the processing server, a data response message containing the hash chain of the one or more units of the scalar digital asset to the computing device.

12. The system of claim 11, wherein the instructions to generate, by the processor of the processing server, a hash chain of the one or more units of the scalar digital asset further comprise:
instructions to apply, by the processor of the processing server, a hash digest function to each of the one or more units of the scalar digital asset using a random initial value.

13. The system of claim 12, wherein each unit of the one or more units of the scalar digital asset is represented by a single hash in the hash chain.

14. The system of claim 12, wherein a range of the one or more units of the scalar digital asset is represented by a start hash and an end hash

15. The system of claim 11, wherein the scalar digital asset is a digital currency.

16. The system of claim 11, wherein one unit of the one or more units of the scalar digital asset is the smallest unit of the scalar digital asset.

17. The system of claim 11, wherein one unit of the one or more units of the scalar digital asset is a designated unit size of the scalar digital asset.

18. The system of claim 11, wherein the scalar digital asset is stored on a blockchain network.

19. The system of claim 11, wherein the hash chain is transferrable in an offline environment by the first computing device to a secondary computing device.

20. The system of claim 11, wherein a designated range of the hash chain is transferrable in an offline environment by the first computing device to a secondary computing device.
